(19) United States
(12) Patent Application Publication
(10) Pub. No.: US 2019/0263507 A1
(43) Pub. Date: Aug. 29, 2019

(54) SYSTEM FOR MOVING AN AIRCRAFT DOOR

(71) Applicants: Airbus Operations Limited, Bristol (GB); Airbus Operations (S.A.S.), Toulouse (FR)

(72) Inventors: Mark HUDSON, Bristol (GB); Matthew GADD, Bristol (GB); Trevor BRIGHTON, Bristol (GB); Graham KING, Bristol (GB); Oliver MCCAMBRIDGE, Bristol (GB); Yann NICOLAS, Bristol (GB)

(21) Appl. No.: 16/287,516

(22) Filed: Feb. 27, 2019

(30) Foreign Application Priority Data
Feb. 28, 2018 (GB) 1803303.5

(51) Int. Cl. B64C 25/30; B64C 25/22; E05F 15/72; E05F 15/50

(52) U.S. Cl. CPC B64C 25/30; B64C 25/22; E05F 15/72; E05F 15/50; E05Y 2400/512; E05Y 2800/252; E05Y 2400/61; E05Y 2201/448; E05Y 2900/502

(57) ABSTRACT

A system for moving an aircraft door from an open position towards a closed position. The system includes an aircraft door actuator, an input receiving primary power from a primary power supply to power movement of the aircraft door from the open position towards the closed position, a secondary power supply to power the aircraft door actuator to move the aircraft door from the open position towards the closed position, and a controller configured to cause the secondary power supply to power the aircraft door actuator to cause the aircraft door actuator to move the aircraft door from the open position towards the closed position, on the basis of a determination that insufficient primary power is available from the primary power supply via the input to move the aircraft door from the open position towards the closed position.

### RELATED APPLICATION

This application claims priority to United Kingdom Patent Application GB1803303.5 filed Feb. 28, 2018, the entirety of which is incorporated by reference.

### TECHNICAL FIELD

The present invention relates to systems for, and methods of, moving an aircraft door from an open position towards a closed position, and to aircraft.

### BACKGROUND

Some conventional aircraft comprise a system for actuating an aircraft door actuator to move an aircraft door between a closed position and an open position and vice versa, and selectively enable movement of the aircraft door from the closed position towards the open position under the influence of gravity alone. Such a safety feature enables the door to be opened in the event that power to actuate the aircraft door actuator is insufficient or unavailable.

### SUMMARY

A first aspect of the present invention provides a system for moving an aircraft door from an open position towards a closed position, the system comprising: an aircraft door actuator for moving the aircraft door from an open position towards a closed position; an input for receiving primary power from a primary power supply, the primary power for use in moving the aircraft door from the open position towards the closed position; a secondary power supply for powering the aircraft door actuator to cause the aircraft door actuator to move the aircraft door from the open position towards the closed position; and a controller configured to cause the secondary power supply to power the aircraft door actuator to cause the aircraft door actuator to move the aircraft door from the open position towards the closed position, on the basis of a determination that insufficient primary power is available from the primary power supply via the input to move the aircraft door from the open position towards the closed position.

Optionally, the system is configured so that primary power received from the primary power supply via the input is for powering the aircraft door actuator to cause the aircraft door actuator to move the aircraft door from the open position towards the closed position.

Optionally, the system comprises an isolator that is switchable between a first state, in which the isolator prevents the secondary power supply from powering the aircraft door actuator, and a second state, in which the isolator permits the secondary power supply to power the aircraft door actuator, wherein the controller is configured to cause the isolator to switch from the first state to the second state, on the basis of the determination that insufficient primary power is available from the primary power supply via the input to move the aircraft door from the open position towards the closed position.

Optionally, the isolator is positioned between the secondary power supply and the aircraft door actuator.

Optionally, the system comprises one or more power sensors to sense an availability of primary power from the primary power supply, and to issue a power availability signal indicating the sensed availability of primary power, wherein the controller is configured to receive the power availability signal and, on the basis of the received power availability signal, to cause the secondary power supply to power the aircraft door actuator to cause the aircraft door actuator to move the aircraft door from the open position towards the closed position.

Optionally, the secondary power supply is configured to supply energy to the aircraft door actuator from an energy store or reservoir, the supplied energy for actuating the aircraft door actuator to move the aircraft door from the open position towards the closed position. Optionally, the secondary power supply comprises a pump for pumping hydraulic fluid from a hydraulic fluid reservoir to the aircraft door actuator.

Optionally, the secondary power supply comprises the energy store or reservoir. Optionally, the secondary power supply comprises a hydraulic accumulator for storing pressurised hydraulic fluid for use in actuating the aircraft door actuator to move the aircraft door from the open position towards the closed position.

Optionally, the system comprises a valve that is switchable between a first state, in which the valve permits hydraulic fluid to flow between a first side and a second side of the aircraft door actuator via the valve to permit non-powered movement of the aircraft door between the closed position and the open position, and a second state, in which the valve prevents hydraulic fluid from flowing between the first side and the second side of the aircraft door actuator via the valve, wherein the controller is configured to cause the valve to switch from the first state to the second state, on the basis of the controller receiving a signal indicating that the aircraft door is to be moved from the open position towards the closed position.

Optionally, the aircraft door is a landing gear door associated with a landing gear, the landing gear configured to be movable between a retracted position and an extended position, and the controller is configured to cause the secondary power supply to power the aircraft door actuator to cause the aircraft door actuator to move the aircraft door from the open position towards the closed position, on the basis of a determination that the landing gear is in the extended position.

Optionally, the system comprises a position sensor to sense that the aircraft door has moved from the open position to a predetermined position, and to issue a door position signal when the aircraft door is in the predetermined position, wherein the controller is configured to receive the door position signal, and to cause the secondary power supply to power the aircraft door actuator to cause the aircraft door actuator to hold the aircraft door in the predetermined position.

Optionally, the controller is configured to prevent powering of the aircraft door actuator by the primary power supply via the input or by the secondary power supply, on the basis of a determination that the aircraft door locked in the closed position.

A second aspect of the present invention provides a system for moving an aircraft door from an open position towards a closed position, the system comprising: an aircraft door actuator for moving the aircraft door from an open position towards a closed position; one or more sensors to sense an availability of primary power from a primary power supply, the primary power for powering the aircraft door actuator to cause the aircraft door actuator to move the aircraft door from the open position towards the closed position, and the one or more sensors to issue a signal indicating the availability of primary power from the primary power supply; a secondary power supply for powering the aircraft door actuator; and a controller configured to receive the signal and, on the basis of the received signal, to cause the secondary power supply to provide power to the aircraft door actuator to cause the aircraft door actuator to move the aircraft door from the open position towards the closed position.

A third aspect of the present invention provides an aircraft comprising a system according to the first aspect of the present invention or the second aspect of the present invention.

A fourth aspect of the present invention provides a method of moving an aircraft door from an open position towards a closed position, the method comprising: determining whether sufficient primary power is available from a main power supply to power an aircraft door actuator to cause the aircraft door actuator to move the aircraft door from an open position towards a closed position; and causing an alternate power supply to power the aircraft door actuator to cause the aircraft door actuator to move the aircraft door from the open position towards the closed position, in the event that it is determined that insufficient primary power is available from the main power supply to power the aircraft door actuator to cause the aircraft door actuator to move the aircraft door from the open position towards the closed position.

Optionally, the alternate power supply is configured to provide sufficient power to cause the aircraft door actuator to move the aircraft door from the open position towards the closed position when power is unavailable from the main power supply.

### BRIEF DESCRIPTION OF THE DRAWINGS

Embodiments of the invention will now be described, by way of example only, with reference to the accompanying drawings, in which:

FIG. 1 shows a schematic view showing a system for moving an aircraft door from an open position towards a closed position, according to an embodiment of the present invention;

FIG. 2 shows a schematic view showing a system for moving an aircraft door from an open position towards a closed position, according to an embodiment of the present invention;

FIG. 3 shows a schematic circuit diagram showing a system for moving an aircraft door from an open position towards a closed position according to an embodiment of the present invention;

FIG. 4 is a flow diagram showing an example of a method according to an embodiment of the present invention; and

FIG. 5 is a schematic front view showing an example of an aircraft according to an embodiment of the present invention.

### DETAILED DESCRIPTION

An open door at an outer surface of an aircraft can disrupt air flow over the surface of the aircraft, which in turn can: increase draft and thus fuel consumption, reduce aircraft speed and/or risk damage to the door. It can therefore be beneficial to close an aircraft door whenever possible.

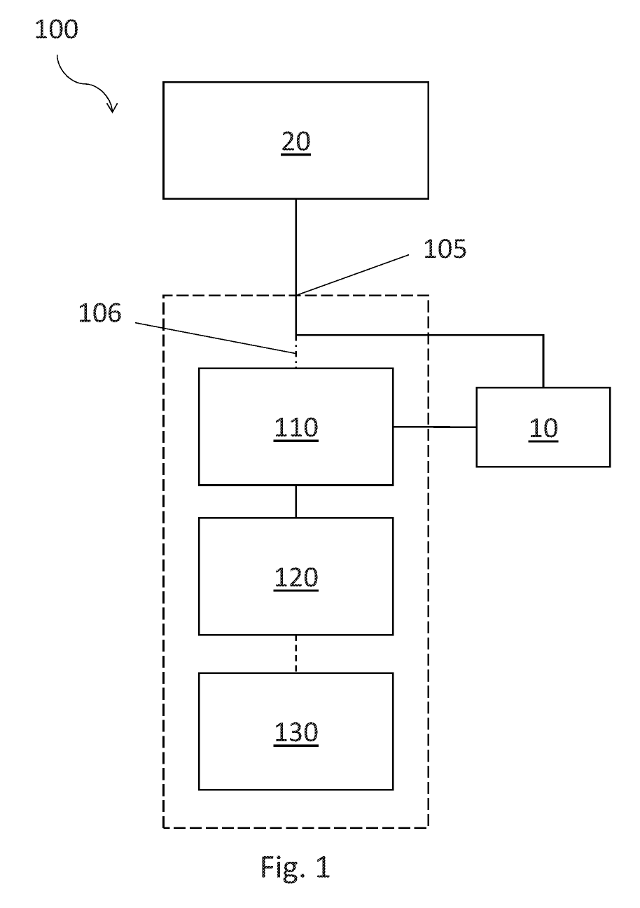

The present invention provides a system for moving an aircraft door from an open position towards a closed position. FIG. 1 is a schematic view showing a system 100 for closing an aircraft door 10 according to an embodiment of the present invention. The system 100 comprises an aircraft door actuator 110 for moving the aircraft door 10 from an open position towards a closed position. In some embodiments, the aircraft door actuator 110 is for moving the aircraft door 10 from the open position to the closed position. In some embodiments, the aircraft door actuator 110 is also for moving the aircraft door 10 from the closed position towards the open position. In some embodiments, the aircraft door actuator 110 comprises a hydraulic actuator. In some embodiments, the aircraft door actuator 110 comprises an electric actuator.

The system 100 also comprises an input 105 for receiving primary power from a primary power supply 20, the primary power for use in moving the aircraft door 10 from the open position towards the closed position. In some embodiments, as denoted by dashed line 106 in FIG. 1, the system 100 is configured so that primary power received from the primary power supply 20 via the input 105 is for powering the aircraft door actuator 110 to cause the aircraft door actuator 110 to move the aircraft door 10 from the open position towards the closed position. In other embodiments, the system 100 is configured so that primary power received from the primary power supply 20 via the input 105 is for use in moving the aircraft door 10 from the open position towards the closed position by some other mechanism. In some embodiments, the primary power supply 20 is a supply of pressurised hydraulic fluid and the aircraft door actuator 110 is a hydraulic actuator. In some embodiments, the primary power supply 20 is a supply of electric power, such as a battery or a capacitor, and the aircraft door actuator 110 is an electric actuator.

The system 100 also comprises a secondary power supply 120 for powering the aircraft door actuator 110 to cause the aircraft door actuator 110 to move the aircraft door 10 from the open position towards the closed position. The system 100 further comprises a controller 130 configured to cause the secondary power supply 120 to power the aircraft door actuator 110 to cause the aircraft door actuator 110 to move the aircraft door 10 from the open position towards the closed position, on the basis of a determination that insufficient primary power is available from the primary power supply 20 via the input 105 to move the aircraft door 10 from the open position towards the closed position. In some embodiments, the determination may be a determination that primary power is unavailable from the primary power supply 20 via the input 105. For example, the controller 130 may be configured to receive an indication of whether power is available and the determination may be based on the indication. In some embodiments, the controller 130 is configured to determine whether insufficient primary energy is available from the primary power supply 20 via the input 105 to move the aircraft door 10 from the open position towards the closed position. In some embodiments, the controller 130 is configured to cause the secondary power supply 120 to power the aircraft door actuator 110 to cause the aircraft door actuator 110 to move the aircraft door 10 from the open position towards the closed position on the basis of the determination and on the basis of one or more predetermined criteria. For example, the predetermined criteria may relate to an operational state of the aircraft.

In some embodiments, the secondary power supply 120 comprises a pump for pumping hydraulic fluid from a hydraulic fluid reservoir to the aircraft door actuator 110. In some embodiments, the pump is an electric pump. In some embodiments, the secondary power supply 120 comprises the hydraulic fluid reservoir.

In some embodiments, the system 100 is configured to move the aircraft door 10 from the open position towards the closed position in response to a determination that a non-powered movement of the aircraft door 10 from the closed position to the open position has occurred. For example, the aircraft door 10 may have moved from the closed position to the open position solely under the influence of gravity. This determination may be made at the controller 130.

In some embodiments, the controller 130 is configured to cause the secondary power supply 120 to power the aircraft door actuator 110 to cause the aircraft door actuator 110 to move the aircraft door 10 from the closed position towards an open position, on the basis of a determination that insufficient primary power is available from the primary power supply via the input to move the aircraft door from the closed position towards the open position.

In some embodiments, the aircraft door 10 is a landing gear door associated with a landing gear, and the landing gear is configured to be movable between a retracted position and an extended position. When the aircraft door 10 is in the closed position, the aircraft door 10 at least partially covers a bay into which the landing gear is received when the landing gear is in the retracted position. In some such embodiments, the controller 130 is configured to cause the secondary power supply 120 to power the aircraft door actuator 110 to cause the aircraft door actuator 110 to move the aircraft door 10 from the open position towards the closed position, on the basis of a determination that the landing gear is in the extended position. In some such embodiments, the system 100 comprises a landing gear sensor to detect a position of the landing gear and to send a landing gear signal indicating a position to the landing gear to the controller, and the controller is configured to determine that the landing gear is in the extended position on the basis of the received landing gear signal.

In some embodiments, the controller 130 is configured to prevent powering of the aircraft door actuator 110 by the primary power supply 20 via the input 105 or by the secondary power supply 120, on the basis of a determination that the aircraft door 10 is locked in the closed position. In some embodiments, the aircraft door 10 may be locked in the closed position by an aircraft door uplock (not shown). In some such embodiments, the system 100 comprises a door lock sensor to detect whether the aircraft door 10 is locked in the closed position and to send a door lock signal to the controller indicating that the aircraft door 10 is locked in the closed position, and the controller is configured to determine that the aircraft door 10 is locked in the closed position on the basis of the received door lock signal.

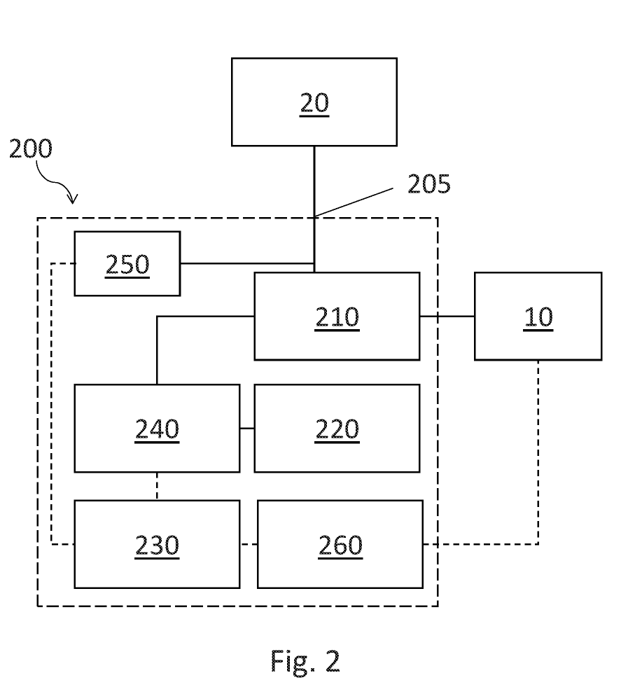

FIG. 2 is a schematic view showing a system 200 for moving an aircraft door 10 from an open position towards a closed position according to an embodiment of the present invention. Components corresponding to those of the system 100 shown in FIG. 1 have the same reference numbers, but increased by 100. The system 200 comprises an input 205, an aircraft door actuator 210, a secondary power supply 220 and a controller 230, as described with reference to FIG. 1. Primary power received from the primary power supply 20 via the input 205 is for powering the aircraft door actuator 210 to cause the aircraft door actuator 210 to move the aircraft door 10 from the open position towards the closed position.

The system 200 comprises an isolator 240 that is switchable between a first state, in which the isolator 240 prevents the secondary power supply 220 from powering the aircraft door actuator 210, and a second state, in which the isolator 240 permits the secondary power supply 220 to power the aircraft door actuator 210. The controller 230 is configured to cause the isolator 240 to switch from the first state to the second state, on the basis of a determination that insufficient primary power is available from the primary power supply 20 via the input 205 to move the aircraft door 10 from the open position towards the closed position. In some embodiments, the determination may be a determination that primary power is unavailable from the power supply 20 via the input 205. In some embodiments, such as that shown in FIG. 2, the isolator 240 is positioned between the secondary power supply 220 and the aircraft door actuator 210. In some embodiments, the controller 230 is configured to determine whether insufficient primary energy is available from the primary power supply 20 via the input 205 to move the aircraft door 10 from the open position towards the closed position. Throughout this application the term “isolator” is used to describe a valve configured to isolate a portion of a hydraulic system from another portion of the hydraulic system.

In some embodiments, the system 200 comprises one or more power sensors 250 to sense an availability of primary power from the primary power supply 20, and to issue a power availability signal indicating the sensed availability of primary power. The controller 230 is configured to receive the power availability signal and, on the basis of the received power availability signal, to cause the secondary power supply 220 to power the aircraft door actuator 210 to cause the aircraft door actuator 210 to move the aircraft door 10 from the open position towards the closed position. In some embodiments, the controller 230 is configured to determine, on the basis of the received power availability signal, whether insufficient primary energy is available from the primary power supply 20 via the input 205 to move the aircraft door 10 from the open position towards the closed position.

In some embodiments, the system 200 comprises a position sensor 260 to sense that the aircraft door 10 has moved from the open position to a predetermined position, and to issue a door position signal when the aircraft door 10 is in the predetermined position. The controller 230 is configured to receive the door position signal and to cause the aircraft door actuator 210 to hold the aircraft door 10 in the predetermined position. In some embodiments, the predetermined position is between the open position and the closed position. It may be beneficial to hold the aircraft door 10 in the predetermined position if, for example, sufficient drag reduction can be achieved by only partially closing the aircraft door 10, or if the secondary power supply 220 only has sufficient power to partially close the aircraft door 10.

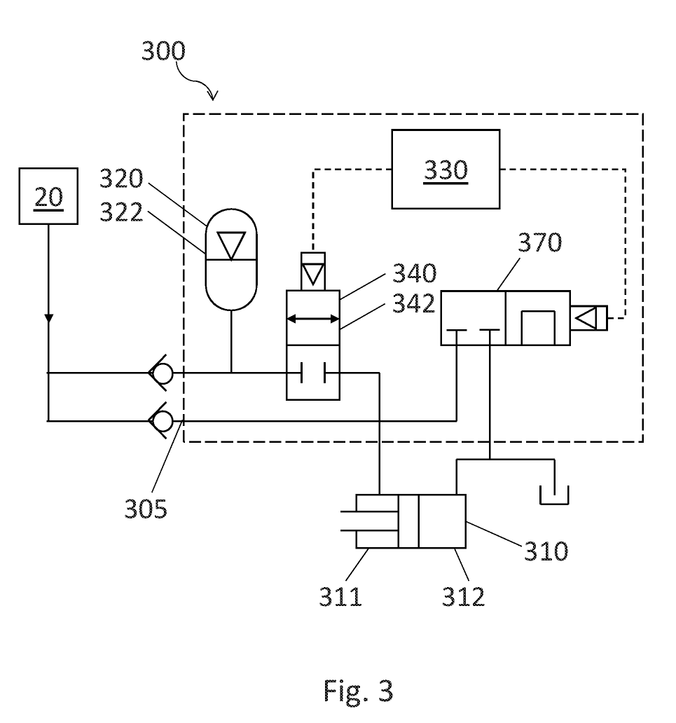

FIG. 3 is a schematic circuit diagram of a system 300 according to an embodiment of the present invention. Components corresponding to those of the system 100 shown in FIG. 1 have the same reference numbers, but increased by 200. The system 300 comprises an input 305, an aircraft door actuator 310, a secondary power supply 320 and a controller 330, as described with reference to FIG. 1 or FIG. 2. Primary power received from the primary power supply 20 via the input 305 is for powering the aircraft door actuator 310 to cause the aircraft door actuator 310 to move the aircraft door 10 (not shown in FIG. 3) from the open position towards the closed position.

In some embodiments, the secondary power supply 320 may supply energy from an energy store or reservoir. The form of supplied energy may be dependent on the type of aircraft door actuator 310 employed by the system 300 to move the aircraft door 10 from the open position towards the closed position. In some embodiments, the secondary power supply 320 may comprise the energy store or reservoir. In the embodiment of FIG. 3, the secondary power supply 320 of the system 300 comprises a hydraulic accumulator 322 for storing pressurised hydraulic fluid for use in actuating the aircraft door actuator 310 to move the aircraft door 10 from the open position towards the closed position. In some embodiments, the secondary power supply 320 may be configured to supply forms of energy to the actuator 310 other than hydraulic energy. For example, the secondary power supply 320 may supply pressurised air, for use with a pneumatic actuator, or may supply electrical energy stored in a battery, for use with an electromechanical actuator. In some embodiments, the secondary power supply 320 comprises two energy stores or reservoirs, which may be for supplying common or respectively different forms of energy.

In some embodiments, the secondary power supply 320 comprises two hydraulic accumulators. In some embodiments, a first of the two hydraulic accumulators has a first volume and is configured to store hydraulic fluid at a first pressure, and a second of the two hydraulic accumulators has a second volume that is smaller than the first volume and is configured to store hydraulic fluid at a second pressure that is higher than the first pressure. The controller 330 may be configured to selectively permit hydraulic fluid to flow from the first and/or second accumulator to the aircraft door actuator 310 on the basis of a position of the aircraft door 10. Such a configuration may be beneficial if the power required to move the aircraft door 10 from the open position towards the closed position is variable over the range of movement. For example, a higher pressure may be required to initiate movement of the aircraft door 10 than for another portion of the movement towards the closed position, so hydraulic fluid may be required initially from the second accumulator and then from the first accumulator.

In some embodiments, the system 300 comprises an isolator 340, as described with reference to the system 200 shown in FIG. 2. In some embodiments, the isolator comprises one or more isolation valves 342. The system 300 shown in FIG. 3 has one isolation valve 342. In FIG. 3, the isolation valve 342 is shown in the first state, in which the hydraulic accumulator 322 is isolated from the aircraft door actuator 310, and is switchable to the second state, in which the hydraulic accumulator 322 is fluidly connected to the aircraft door actuator 310.

In some embodiments, such as that shown in FIG. 3, the system 300 comprises a valve 370 that is switchable between a first state and a second state. In some embodiments, the valve 370 is switchable to the first state to facilitate non-powered movement of the aircraft door 10 between the closed position and the open position, for example solely under the influence of gravity, and switchable to the second state to facilitate powered actuation of the aircraft door actuator 310. For example, in this embodiment, in the first state the valve 370 permits hydraulic fluid to flow between a first side 311 and a second side 312 of the aircraft door actuator 310 via the valve 370 to permit non-powered movement of the aircraft door 10 between the closed position and the open position. Accordingly, non-powered actuation of the aircraft door actuator 310 is permitted, which may help to permit movement of the aircraft door 10 from the closed position towards the open position, for example, under gravity. In the second state, the valve 370 prevents hydraulic fluid from flowing between the first side 311 and the second side 312 of the aircraft door actuator 310 via the valve 370, therefore permitting powered actuation of the aircraft door actuator 310. In FIG. 3, the valve 370 is shown in the second state.

In some embodiments, the controller 330 is configured to cause the valve 370 to switch from the first state to the second state, on the basis of the controller 330 receiving a closing signal indicating that the aircraft door 10 is to be moved from the open position towards the closed position. Such a closing signal may be received from a cockpit of the aircraft or from a landing gear extension and retraction system, for example.

In some embodiments, the system 300 comprises one or more power sensors and/or a position sensor, as described with reference to FIG. 2. Such sensors may be configured to provide respective signals to the controller and, on the basis of the received signals, the controller may be configured to cause the aircraft door actuator to move the aircraft door from the open position towards the closed position.

Some embodiments of the present invention comprise a system for moving an aircraft door from an open position towards a closed position, the system comprising: an aircraft door actuator for moving the aircraft door from an open position towards a closed position, one or more sensors to sense an availability of primary power from a primary power supply, the primary power for powering the aircraft door actuator to cause the aircraft door actuator to move the aircraft door from the open position towards the closed position, and the one or more sensors to issue a signal indicating the availability of primary power from the primary power supply, a secondary power supply for powering the aircraft door actuator, and a controller configured to receive the signal and, on the basis of the received signal, to cause the secondary power supply to provide power to the aircraft door actuator to cause the aircraft door actuator to move the aircraft door from the open position towards the closed position. The content of each of FIGS. 1-3 embodies such a system.

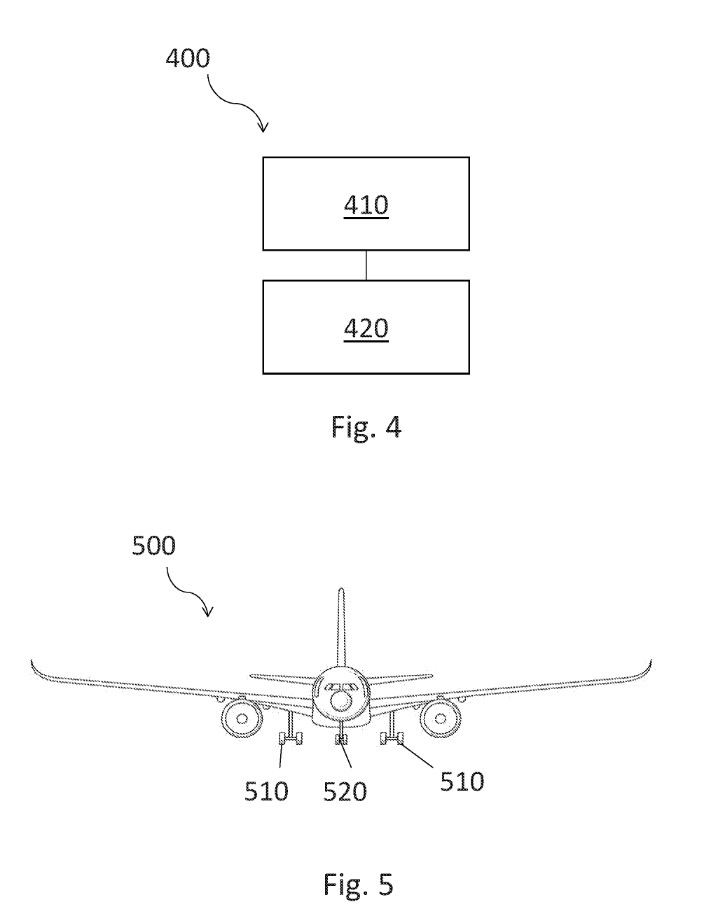

Some embodiments of the present invention comprise a method 400 of moving an aircraft door from an open position towards a closed position, as shown in FIG. 4. The method 400 comprises: determining 410 whether sufficient primary power is available from a main power supply to power an aircraft door actuator to cause the aircraft door actuator to move the aircraft door from an open position towards a closed position, and causing 420 an alternate power supply to power the aircraft door actuator to cause the aircraft door actuator to move the aircraft door from the open position towards the closed position, in the event that it is determined that insufficient primary power is available from the main power supply to power the aircraft door actuator to cause the aircraft door actuator to move the aircraft door from the open position towards the closed position. The method 400 may be performed using any one of the systems shown in FIGS. 1-3, such as by one of the controllers 130, 230, 330.

In some embodiments, the alternate power supply is configured to provide sufficient power to cause the aircraft door actuator to move the aircraft door from the open position towards the closed position when power is unavailable from the main power supply.

Some embodiments of the present invention provide an aircraft 500, as shown by way of example in FIG. 5. In some embodiments, the aircraft 500 comprises one or more main landing gears 510 and a nose landing gear 520. In some embodiments, the aircraft 500 comprises a system 100, 200, 300 for closing an aircraft door according to any of the embodiments described herein. Some embodiments of the invention provide an aircraft 500 configured to perform a method 400 according to any of the embodiments described herein.

It is to noted that the term “or” as used herein is to be interpreted to mean “and/or”, unless expressly stated otherwise.

The above embodiments are to be understood as non-limiting illustrative examples of how the present invention, and aspects of the present invention, may be implemented. Further examples of the present invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the present invention, which is defined in the accompanying claims.

The invention is:

1. A system for moving an aircraft door from an open position towards a closed position, the system comprising:
an aircraft door actuator configured to move the aircraft door from an open position towards a closed position;
an input configured to receive primary power from a primary power supply, the primary power for use in moving the aircraft door from the open position towards the closed position;
a secondary power supply configured to power the aircraft door actuator to cause the aircraft door actuator to move the aircraft door from the open position towards the closed position; and
a controller configured to cause the secondary power supply to power the aircraft door actuator to cause the aircraft door actuator to move the aircraft door from the open position towards the closed position, on the basis of a determination that insufficient primary power is available from the primary power supply via the input to move the aircraft door from the open position towards the closed position.

2. The system according to claim 1, configured so that primary power received from the primary power supply via the input is for powering the aircraft door actuator to cause the aircraft door actuator to move the aircraft door from the open position towards the closed position.

3. The system according to claim 1, comprising an isolator that is switchable between a first state, in which the isolator prevents the secondary power supply from powering the aircraft door actuator, and a second state, in which the isolator permits the secondary power supply to power the aircraft door actuator,
wherein the controller is configured to cause the isolator to switch from the first state to the second state, on the basis of the determination that insufficient primary power is available from the primary power supply via the input to move the aircraft door from the open position towards the closed position.

4. The system according to claim 3, wherein the isolator is positioned between the secondary power supply and the aircraft door actuator.

5. The system according to claim 3, comprising one or more power sensors to sense an availability of primary power from the primary power supply, and to issue a power availability signal indicating the sensed availability of primary power,
wherein the controller is configured to receive the power availability signal and, on the basis of the received power availability signal, to cause the secondary power supply to power the aircraft door actuator to cause the aircraft door actuator to move the aircraft door from the open position towards the closed position.

6. The system according to claim 1, wherein the secondary power supply is configured to supply energy to the aircraft door actuator from an energy store or reservoir.

7. The system according to claim 1, wherein the secondary power supply comprises a pump for pumping hydraulic fluid from a hydraulic fluid reservoir to the aircraft door actuator.

8. The system according to claim 6, wherein the secondary power supply comprises the energy store or reservoir.

9. The system according to claim 1, wherein the secondary power supply comprises a hydraulic accumulator for storing pressurised hydraulic fluid for use in actuating the aircraft door actuator to move the aircraft door from the open position towards the closed position.

10. The system according to claim 1 comprising:
a valve that is switchable between a first state, in which the valve permits hydraulic fluid to flow between a first side and a second side of the aircraft door actuator via the valve to permit non-powered movement of the aircraft door between the closed position and the open position, and a second state, in which the valve prevents hydraulic fluid from flowing between the first side and the second side of the aircraft door actuator via the valve,
wherein the controller is configured to cause the valve to switch from the first state to the second state, on the basis of the controller receiving a signal indicating that the aircraft door is to be moved from the open position towards the closed position.

11. The system according to claim 1, wherein the aircraft door is a landing gear door associated with a landing gear, the landing gear configured to be movable between a retracted position and an extended position, and
wherein the controller is configured to cause the secondary power supply to power the aircraft door actuator to cause the aircraft door actuator to move the aircraft door from the open position towards the closed position, on the basis of a determination that the landing gear is in the extended position.

12. The system according to claim 1, comprising a position sensor to sense that the aircraft door has moved from the open position to a predetermined position, and to issue a door position signal when the aircraft door is in the predetermined position,
wherein the controller is configured to receive the door position signal, and to cause the secondary power supply to power the aircraft door actuator to cause the aircraft door actuator to hold the aircraft door in the predetermined position.

13. The system according to claim 1, wherein the controller is configured to prevent powering of the aircraft door actuator by the primary power supply via the input or by the secondary power supply, on the basis of a determination that the aircraft door is locked in the closed position.

14. A system for moving an aircraft door from an open position towards a closed position, the system comprising:
an aircraft door actuator configured to move the aircraft door from an open position towards a closed position;
one or more sensors configured to sense an availability of primary power from a primary power supply, the primary power for powering the aircraft door actuator to cause the aircraft door actuator to move the aircraft door from the open position towards the closed position, and the one or more sensors to issue a signal indicating the availability of primary power from the primary power supply;
a secondary power supply configured to power the aircraft door actuator; and
a controller configured to receive the signal and, on the basis of the received signal, to cause the secondary power supply to provide power to the aircraft door actuator to cause the aircraft door actuator to move the aircraft door from the open position towards the closed position.

15. An aircraft comprising the system of claim 1.

16. A method of moving an aircraft door from an open position towards a closed position, the method comprising:
determining whether sufficient primary power is available from a main power supply to power an aircraft door actuator to cause the aircraft door actuator to move the aircraft door from an open position towards a closed position; and
causing an alternate power supply to power the aircraft door actuator to cause the aircraft door actuator to move the aircraft door from the open position towards the closed position, in the event that it is determined that insufficient primary power is available from the main power supply to power the aircraft door actuator to cause the aircraft door actuator to move the aircraft door from the open position towards the closed position.

17. The method according to claim 16, wherein the alternate power supply is configured to provide sufficient power to cause the aircraft door actuator to move the aircraft door from the open position towards the closed position when power is unavailable from the main power supply.
